(19) United States
(12) Patent Application Publication
(10) Pub. No.: US 2021/0335540 A1
(43) Pub. Date: Oct. 28, 2021

(54) METHOD OF MANUFACTURING RARE-EARTH PERMANENT MAGNET AND RARE-EARTH PERMANENT MAGNET MANUFACTURED BY THE SAME

(71) Applicants: Hyundai Motor Company, Seoul (KR); Kia Motors Corporation, Seoul (KR)

(72) Inventors: Bo Kyeong Han, Hwaseong (KR); Dong Hwan Kim, Daegu (KR); Koon Seung Kong, Daegu (KR)

(73) Assignees: Hyundai Motor Company, Seoul (KR); Kia Motors Corporation, Seoul (KR); Kia Motors Corporation, Seoul (KR)

(21) Appl. No.: 17/092,854

(22) Filed: Nov. 9, 2020

(30) Foreign Application Priority Data
Apr. 23, 2020 (KR) 10-2020-0049617

(51) Int. Cl. H01F 41/02; H01F 1/057; C23C 4/18

(52) U.S. Cl. CPC H01F 41/0293; C23C 4/18; H01F 1/0572

(57) ABSTRACT

Disclosed are a method of manufacturing a rare-earth permanent magnet capable of offsetting a partially uneven demagnetization by varying the amount of heavy rare-earth element diffused to a grain boundary for each region and a Nd—Fe—B-based permanent magnet manufactured by the same.

The method includes: preparing a base material including a plurality of regions by using a sintered magnet including an Nd—Fe—B-based alloy; preparing a coating material including a heavy rare-earth element; applying the coating material to a surface of the base material; and diffusing the heavy rare-earth element to a grain boundary of the base material by heat-treating the base material to which the coating material is applied. In the applying the coating material, an amount of the coating material applied to each region of the base material may vary.

### CROSS REFERENCE TO RELATED APPLICATION

The present application claims priority to Korean Patent Application No. 10-2020-0049617, filed Apr. 23, 2020, the entire contents of which is incorporated herein for all purposes by this reference.

### TECHNICAL FIELD

The present invention relates to a method of manufacturing a rare-earth permanent magnet. The method of manufacturing a rare-earth permanent magnet is capable of offsetting a partially uneven demagnetization by varying the amount of heavy rare-earth element diffused to a grain boundary for each region.

### BACKGROUND

A rare-earth permanent magnet is a magnet having an excellent magnetic force, such as an R—Fe—B sintered magnet (here, “R” represents a rare-earth element such as neodymium (Nd), dysprosium (Dy), or terbium (Tb), or a rare-earth element combination). The rare-earth permanent magnet may implement an increase in output and a reduction in size of a motor, and thus has been applied in various fields such as home appliances and a motor of a vehicle. Furthermore, the rare-earth permanent magnet has been increasingly used in a new energy field such as a generator as well as an electronic communication field such as a mobile phone.

Recently, studies on a rare-earth permanent magnet capable of maintaining excellent magnetic properties while reducing a content of a relatively expensive rare-earth element have been continuously conducted.

Currently, a method of manufacturing a permanent magnet with a reduced content of a rare-earth element may include using a magnet crystal grain refining technology and using a grain boundary diffusing technology. Among them, the grain boundary diffusing technology has been frequently used in terms of cost-effectiveness due to a reduction in amount of the rare-earth element used.

Meanwhile, an interior permanent magnet (IPM) motor has been widely used as a motor for an eco-friendly vehicle is configured to insert a permanent magnet into a rotor. A magnitude of a magnetic field applied to the rotor partially varies depending on a size or an angle of the permanent magnet to be inserted, which is known to be difficult to solve due to a design of the motor.

For example, in the IPM motor, an intensive demagnetization field is partially applied to a corner portion of the permanent magnet rather than to a surface of the permanent magnet, and thus, the permanent magnet is partially demagnetized, which causes a performance degradation of the motor.

The contents described as the related art have been provided only for assisting in the understanding for the background of the present invention and should not be considered as corresponding to the related art known to those skilled in the art.

### SUMMARY

In preferred aspects, provided is a method of manufacturing a rare-earth permanent magnet capable of offsetting a partially uneven demagnetization by varying the amount of heavy rare-earth element diffused to a grain boundary for each region.

In an aspect, provided is a method of manufacturing a rare-earth permanent magnet including:

preparing a base material including a plurality regions by using an Nd—Fe—B-based alloy; preparing a coating material including a heavy rare-earth element; applying the coating material to a surface of the base material so that an amount of the coating material to be applied to each region of the base material varies; and diffusing the heavy rare-earth element in the coating material to a grain boundary of the base material by heat-treating the base material to which the coating material is applied. Preferably, the base material may be a sintered magnet material using the Nd—Fe—B-based alloy.

A term “region” as used herein refers to a part of surficial location that is defined by a specific characteristics (e.g., material, area, shape, size, pattern, thickness, surficial feature or coating, or the like). The “plurality of (the) regions” may include two or more distinctive parts of the surfaces, each of the regions may have the same or different characteristics (e.g., material, area, shape, size, pattern, thickness, surficial feature or coating, or the like) from each other. For example, the regions may include at least a first region, a second region a third region, a fourth region, a fifth region, or the like.

A term “diffusion” or “diffusing” as used herein refers to a process for or during producing an alloy, and in the diffusion process, certain components (e.g., metal elements or atoms) among different alloy components transfer, move, or diffuse, thereby changing chemical composition of a part of the alloy regions.

The coating material may include a heavy rare-earth element powder including the heavy-rare earth element.

The heavy rare-earth powder may be one or two or more selected from the group consisting of hydride, fluoride, oxide, acid fluoride, and alloy of the heavy rare-earth element.

The heavy rare-earth powder may include one or both of Dy and Tb in an amount of about 10 wt % or greater based on the total weight of the heavy rare-earth powder.

The coating material may be applied to the surface of the base material by spray coating.

The coating material may be applied by steps including: first applying the coating material uniformly to the surface of the base material, and second applying partially the coating material to the surface of the base material to which the coating material is applied.

For example, the first applying the coating material may be uniformly applying the coating material, or uniform coating. The second applying the coating material may be partially applying the coating material, or partial coating.

The second applying the coating material may be repeated at least twice while changing the region to which the coating material is applied.

An amount of the coating material to be applied in the second applying may be about 10 wt % or greater based on an amount of the coating material in the first applying.

The region subjected to the second applying may include a corner region of the base material.

The diffusing the heavy rare-earth element may include; first heating the charged base material at a temperature at which the coating material is diffused; first cooling the heated base material to room temperature; second heating the charged base material at a temperature at which stress inside the base material is removed; and second cooling the heated base material to room temperature.

Further, the method may optionally include, in the diffusing the heavy rare-earth element, first charging the base material to which the coating material is applied into a heating furnace in a vacuum or inert atmosphere and second charging the cooled base material into the heating furnace in the vacuum or inert atmosphere.

The first heating may be performed at a temperature of about 500 to 1,000° C. for about 1 to 50 hours.

A heating rate in the first heating may be about 0.1 to 10° C./min.

The second heating may be performed at a temperature of about 500 to 1,000° C. for about 1 to 50 hours.

The second heating may be performed at a temperature of about 500 to 950° C. for about 1 to 50 hours.

A heating rate in the second heating may be about 0.1 to 10° C./min.

In another aspect, provided is a Nd—Fe—B-based permanent magnet including a heavy rare-earth element diffused to a grain boundary, wherein a maximum variation between coercive forces in an inner region and an outer region may be 5% or greater.

The coercive force in the inner region may be about 22.5 kOe or greater.

An average coercive force of the coercive force in the inner region and the coercive force in the outer region may be about 26.0 kOe or greater.

Other aspects of the inventions are disclosed infra.

### BRIEF DESCRIPTION OF THE DRAWINGS

FIG. 1 shows an exemplary base material to which an exemplary coating material is applied by an exemplary method of manufacturing a rare-earth permanent magnet according to an exemplary embodiment of the present invention.

FIG. 2 shows an exemplary base material in which an exemplary coating material is diffused by an exemplary method of manufacturing a rare-earth permanent magnet according to an exemplary embodiment of the present invention.

FIGS. 3A and 3B show, respectively, an exemplary base material to which an exemplary coating material is applied and the base material in which the coating material is diffused according to a comparative example and an example according to an exemplary embodiment of the present invention.

### DETAILED DESCRIPTION

Hereinafter, embodiments of the present invention will be described in more detail with reference to the accompanying drawings. However, the present invention is not limited to the disclosed embodiments below, but may be implemented in various different forms. The embodiments are provided to only complete the present invention and to allow those skilled in the art to fully understand the category of the present invention. In the drawings, the same reference numerals denote the same elements. Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

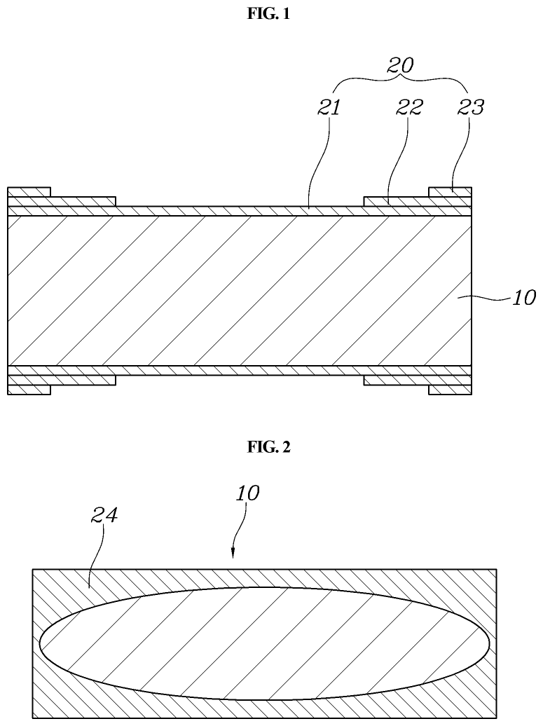

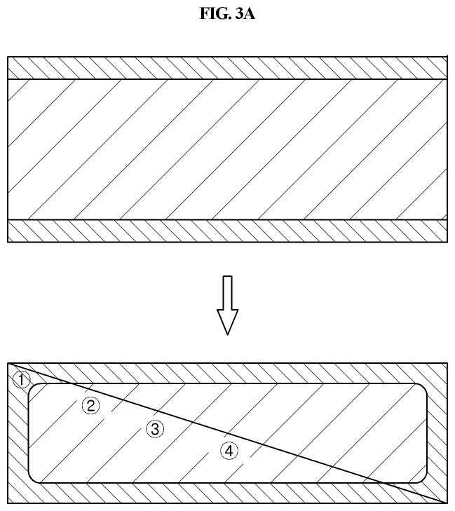

FIG. 1 shows an exemplary base material to which an exemplary coating material is applied by an exemplary method of manufacturing an exemplary rare-earth permanent magnet according to an exemplary embodiment of the present invention. FIG. 2 shows an exemplary base material in which an exemplary coating material is diffused by an exemplary method of manufacturing a rare-earth permanent magnet according to an exemplary embodiment of the present invention.

The method of manufacturing a rare-earth permanent magnet according to an exemplary embodiment of the present invention includes steps of: a base material preparation step of preparing a base material including a plurality regions by using an Nd—Fe—B-based alloy; a coating material preparation step of preparing a coating material containing heavy rare-earth powder; an application step of applying the coating material to a surface of the base material so that an amount of the coating material to be applied to each region of the base material varies; and a grain boundary diffusion step of diffusing a heavy rare-earth element contained in the coating material to a grain boundary of the base material by heat-treating the base material to which the coating material is applied.

The base material preparation step may include preparing a base material of a sintered magnet, and for example, a base material may be prepared using an Nd—Fe—B-based alloy.

For example, a rare-earth magnetic ribbon may be prepared by scrip-casting Nd, B, Fe, and other inevitable impurities. In this case, a transition metal may be further included.

The prepared rare-earth magnetic ribbon may be crushed to prepare rare-earth magnet powder, and the prepared rare-earth magnet powder may be filled in a mold. Then, a direct magnetic field may be applied to an electromagnet disposed on each of both sides of the mold to orient and compress the rare-earth magnet powder, thereby preparing a rare-earth magnet shaped body.

The rare-earth magnet shaped body prepared as described above is charged into a sintering furnace and the charged rare-earth magnet shaped body is sintered to prepare a rare-earth sintered magnet.

The prepared rare-earth sintered magnet may be used as a base material.

The coating material preparation step is a step of preparing a coating material including a heavy rare-earth element applied to the prepared base material and diffused to a grain boundary.

Preferably, in the coating material preparation step, the heavy rare-earth may be in a form of powder and the coting material may include the heavy rare-earth powder. The heavy rare-earth powder and a solvent may be mixed with each other to prepare a coating material in a slurry state. For example, the heavy rare-earth powder may include one or two or more selected from the group consisting of a hydride, fluoride, oxide, acid fluoride, and alloy of the heavy rare-earth element. In particular, the heavy rare-earth powder may include a hydride, fluoride, oxide, acid fluoride, or alloy of one or both of Dy and Tb. For example, the heavy rare-earth powder may include the one or both of Dy and Tb in an amount of about 10 wt % or greater based on the total weight of the heavy rare-earth powder. For example, a Tb—H compound (terbium hydride) and ethanol may be kneaded and crushed to prepare a coating material in a uniform slurry state.

After the base material and the coating material are prepared, the coating material is applied to the surface of the base material.

In the application step, the coating material may be applied to the surface of the base material by spray coating and the amount of the coating material to be applied to each region of the base material may vary. The coating material may be non-uniformly applied to the surface of the base material for each region.

For example, the application step may include a first application step, or a uniform application step of uniformly applying the coating material to the surface of the base material. The application step may optionally include a second application step, or additional application step of additionally (second) and partially applying the coating material to the surface of the base material to which the coating material is uniformly applied.

The additional application step may be repeated at least twice while changing a region to which the coating material is applied. Therefore, an amount of the coating material to be applied in the additional application step may be set to about 10 wt % or greater of an amount of the coating material to be applied to the base material in the first (uniform) application step.

When the base material is applied to a permanent magnet applied to an interior permanent magnet (IPM) motor, the region subjected to the additional application step may be preferably a region including a corner region of the base material.

As shown in FIG. 1, a first coating layer 21 may be formed on the surface of the base material in a uniform thickness and coating amount in the uniform application step. In addition, a second coating layer 22 and a third coating layer 23 may be formed in the corner region of the base material in the repeated additional application step.

For example, a coating layer 20 may be non-uniformly formed on the surface of the base material due to variations in thickness and coating amount for each region by the first coating layer 21 to the third coating layer 23.

After the coating layer is formed on the surface of the base material in the uneven thickness and coating amount for each region, the heavy rare-earth element contained in the coating layer may be diffused to the grain boundary of the base material by heat-treating the coating layer.

The grain boundary diffusion step includes: a first heating step of first charging the base material to which the coating material is applied into a heating furnace in a vacuum or inert atmosphere and first heating the charged base material at a temperature at which the coating material is diffused; a first cooling step of first rapidly cooling the heated base material to room temperature; and a second heating step of second charging the cooled base material into the heating furnace in the vacuum or inert atmosphere and second heating the charged base material at a temperature at which stress inside the base material is removed. In addition, in the second heating step, a second cooling step of rapidly cooling the heated base material at room temperature again may further be performed.

The first heating step may be preferably performed at a temperature of about 500 to 1,000° C. for about 1 to 50 hours.

When the temperature is less than about 500° C., the heavy rare-earth element may not be sufficiently or smoothly diffused, and when the temperature is greater than about 1,000° C., a coercive force may be reduced due to growth of crystal grains in the rare-earth permanent magnet to be manufactured. Therefore, the temperature in the first heating step is preferably limited to the above ranges.

Meanwhile, the second heating step is a step of inducing stable diffusion of the heavy rare-earth element diffused to the surface of the base material in the first heating step into the base material. The stress generated due to sizes of the elements replacing each other may be removed during the second heating step. To this end, the second heating step may be preferably performed at a temperature of about 500 to 1,000° C. for about 1 to 50 hours, and particularly be performed at a temperature of about 500 to 950° C. for about 1 to 50 hours.

When the temperature is less than about 500° C., productivity may be reduced due to long time required to remove the stress and the material diffused to the surface of the base material may be difficult to stably diffuse into the magnet, and when the temperature is greater than about 1,000° C., the crystal grains in the rare-earth permanent magnet may be grown or magnetic characteristics such as a coercive force are degraded due to a change of a distribution of the diffused heavy rare-earth elements. Therefore, the temperature in the second heating step is preferably limited to the above ranges.

As shown in FIG. 2, in the permanent magnet manufactured as described above, a coating material 24 may be further diffused to the corner region of the base material. Therefore, a rare-earth permanent magnet in which a maximum variation in the coercive force for each region may be about 5% or greater may be manufactured. Preferably, a rare-earth permanent magnet in which the maximum variation in the coercive force for each region may be 10% or greater may be manufactured.

### Example

Hereinafter, the present invention will be described with reference to a comparative example and examples.

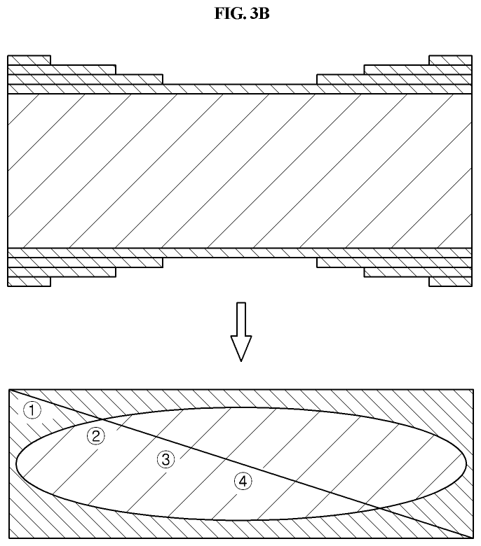

FIGS. 3A and 3B show an exemplary base material to which a coating material is applied and the base material in which the coating material is diffused according to a comparative example and an example according to an exemplary embodiment of present invention, respectively.

First, a base material was prepared by cutting an Nd—Fe—B sintered magnet into a size of about 20 mm (L)*20 mm (W)*5 mm (T) (magnetic field direction). In addition, the base material was subjected to ultrasonic cleaning to remove oil and foreign matters on a surface of the base material.

Then, a Tb—H compound (terbium hydride) and ethanol were kneaded and crushed to prepare a coating material in a uniform slurry state.

By using the base material and the coating material prepared as described above, in the comparative example, the coating material was applied to each of both magnetic field surfaces of the base material in a uniform thickness.

In addition, in the example, a coating layer having a relatively large thickness in a corner region of the base material was formed. Particularly, a plurality of coating layers having uniform thicknesses were formed so that positions at which the coating layers were formed were concentrated on the corner region of the base material.

In this case, the coating amount of the coating material in each of the comparative example and the example was 0.15 g.

Then, the prepared base material was charged into a vacuum furnace, an initial degree of vacuum was maintained at 10⁻⁵ torr, the base material was gradually heated at a heating rate of 4° C./min and then was heated at a temperature of 900° C. for 6 hours to maintain diffusion of the applied Tb—H compound powder into the base material, and the heated base material was rapidly cooled to room temperature. Subsequently, the base material was subjected to a heat treatment for 2 hours by increasing the temperature of the vacuum furnace again to a temperature of 500° C., and the heated base material was rapidly cooled to room temperature, thereby completing the grain boundary diffusion step.

A surface of a sample obtained in each of the comparative example and the example in which the diffusion was completed was polished in 0.2 mm, and as illustrated in FIGS. 3A and 3B, the sample was cut in a direction diagonally across the base material. Then, magnetic characteristics in each region of the cut surface were measured using a BH tracer, and a component analysis was carried out using ICP. The results thereof are shown in Tables 1 and 2.

TABLE 1

| | Coercive force (kOe) for each region | | | | |
|---|---|---|---|---|---|
| Classification | 1 | 2 | 3 | 4 | Total |
| Comparative Example | 27.5 | 26.9 | 26.5 | 26 | 26.8 |
| Example | 29.7 | 27.4 | 25.7 | 24.5 | 26.7 |

TABLE 2

| | Tb content (wt %) for each region | | | | |
|---|---|---|---|---|---|
| Classification | 1 | 2 | 3 | 4 | Total |
| Comparative Example | 1.05 | 0.72 | 0.66 | 0.63 | 0.7 |
| Example | 2.1 | 1.25 | 0.65 | 0.44 | 0.7 |

As shown in Table 1, in the comparative example in which the coating layer was uniformly formed and the heavy rare-earth element was diffused to the grain boundary, the variation in the coercive force for each region was not large. In contrast, in the example in which the coating layer was non-uniformly formed and the heavy rare-earth element was diffused to the grain boundary, the variation in the coercive force for each region was large.

In addition, as shown in Table 2, in the comparative example in which the coating layer was uniformly formed and the heavy rare-earth element was diffused to the grain boundary, Tb was relatively uniformly diffused for each region, whereas, in the example in which the coating layer was non-uniformly formed and the heavy rare-earth element was diffused to the grain boundary, the variation in amount of Tb diffused for each region was generated.

Therefore, a magnet in which a coercive force is partially increased in a corner can be manufactured according to the example, such that it is possible to suppress a demagnetization field generated in an IPM motor and concentrated on the corner of the magnet.

Next, a test for confirming an influence of the heating rate in the first heating step on the coercive force in the grain boundary diffusion step was carried out.

First, a base material was prepared by cutting an Nd—Fe—B sintered magnet into a size of 20 mm (L)*20 mm (W)*5 mm (T) (magnetic field direction). In addition, the base material was subjected to ultrasonic cleaning to remove oil and foreign matters on a surface of the base material.

Then, a Tb—H compound (terbium hydride) and ethanol were kneaded and crushed to prepare a coating material in a uniform slurry state.

By using the base material and the coating material prepared as described above, a coating layer having a relatively large thickness in a corner region of the base material was formed. Particularly, a plurality of coating layers having uniform thicknesses were formed so that positions at which the coating layers were formed were concentrated on the corner region of the base material.

Then, the prepared base material was charged into a vacuum furnace, an initial degree of vacuum was maintained at 10⁻⁵ torr, the base material was heated from room temperature while changing a heating rate to 1 to 10° C./min and then was heated at a temperature of 900° C. for 6 hours to maintain diffusion of the applied Tb—H compound powder into the base material, and the base material was rapidly cooled to room temperature. Subsequently, the base material was subjected to a heat treatment for 2 hours by increasing the temperature of the vacuum furnace again to a temperature of 500° C., and the heated base material was rapidly cooled to room temperature, thereby completing the grain boundary diffusion step.

A surface of a sample obtained in the example in which the diffusion was completed was polished in 0.2 mm, and as illustrated in FIG. 3B, the sample was cut in a direction diagonally across the base material. Then, magnetic characteristics in each of \textcircled{1} a region (outer side) and \textcircled{4} a region (inner side) of FIG. 3B were measured using a BH tracer. The results thereof are shown in Table 3.

TABLE 3

| | | | First | Second | | | |
|---|---|---|---|---|---|---|---|
| | Coating | Heating | heating | heating | Coercive force (kOe) | | |
| | amount | rate | temperature | temperature | Outer | Inner | |
| Classification | (g) | (° C./min) | (° C.) | (° C.) | side | side | Average |
| Example 1 | 0.15 | 1 | 900 | 500 | 28.5 | 26.5 | 27.3 |
| Example 2 | 0.15 | 2 | 900 | 500 | 29.1 | 25.3 | 27.1 |
| Example 3 | 0.15 | 4 | 900 | 500 | 29.7 | 24.5 | 26.7 |
| Example 4 | 0.15 | 6 | 900 | 500 | 30.1 | 23.7 | 26.4 |
| Example 5 | 0.15 | 10 | 900 | 500 | 30.3 | 23.6 | 26.2 |
| Comparative | 0.15 | 20 | 900 | 500 | 29.5 | 22.1 | 25.8 |
| Example 1 | | | | | | | |

As shown in Table 3, as the heating rate was high, the variation of the coercive forces in the inner side and the outer side of the base material was large, but an average coercive force was relatively low.

On the contrary, as the heating rate was low, the variation of the coercive forces in the inner side and the outer side of the base material was small, but the average coercive force was relatively high.

Accordingly, a desire coercive force for each region and a desired average coercive force were adjusted by controlling the heating rate.

In addition, when the heating rate was greater than 10° C./min as in Comparative Example 1, the variation of the coercive forces in the inner side and the outer side of the base material was significantly large, and the average coercive force was relatively low as compared to those in the examples. The reason was that a pool was formed on the surface of the base material by the diffused material due to rapid diffusion, and thus, the material was not easily diffused into the base material.

Meanwhile, although not included in the test, when the heating rate is less than about 0.1° C./min, it may take too long time to reach a desired temperature, which leads to inefficient productivity. Therefore, the heating rate may be preferably maintained at about 0.1° C./min.

Therefore, the heating rate in each of the first heating step and the second heating step may be preferably maintained at about 0.1 to 10° C./min.

In addition, as shown in Table 3, in the rare-earth permanent magnet according to each of the present examples, the coercive force of the inner region was 22.5 kOe or greater.

In addition, in the rare-earth permanent magnet according to exemplary embodiments in the present examples, the average coercive force of the coercive force in the inner region and the coercive force in the outer region was 26.0 kOe or greater.

As set forth above, according to various exemplary embodiments of the present invention, the permanent magnet in which the coercive force is partially increased in a desired region may be manufactured by varying the amount of the coating material to be applied to each of a region in which demagnetization relatively frequently occurs and the other regions in the step of applying the coating material containing the rare-earth element to the base material of the permanent magnet and diffusing the rare-earth element to the grain boundary.

Further, according to various exemplary embodiments of the present invention, the permanent magnetic having the corner region on which the rare-earth element is concentrated may be manufactured, and a demagnetization field concentrated on the corner of the permanent magnetic may be suppressed by applying the manufactured permanent magnetic to an IPM motor, such that durability and efficiency of the motor may be improved.

Although the present invention has been described with reference to the accompanying drawings and the various exemplary embodiments described above, the present invention is not limited thereto but is defined by the claims below. Therefore, those skilled in the art will appreciate that various modifications and changes are possible, without departing from the technical spirit of the claims to be described below.

What is claimed is:

1. A method of manufacturing a rare-earth permanent magnet, comprising:
preparing a base material comprising a plurality of regions by using an Nd—Fe—B-based alloy;
preparing a coating material comprising a heavy rare-earth element;
applying the coating material to a surface of the base material wherein an amount of the coating material applied to each region of the base material varies; and
diffusing the heavy rare-earth element in the coating material to a grain boundary of the base material by heat-treating the base material to which the coating material is applied.

2. The method of claim 1, wherein the coating material comprises a heavy rare-earth element powder comprising the heavy-rare earth element.

3. The method of claim 2, wherein the heavy rare-earth powder comprises one or more selected from the group consisting of hydride, fluoride, oxide, acid fluoride, and alloy of the heavy rare-earth element.

4. The method of claim 3, wherein, the heavy rare-earth powder comprises one or both of Dy and Tb in an amount of about 10 wt % or greater based on the total weight of the powder.

5. The method of claim 1, wherein the coating material is applied to the surface of the base material by spray coating.

6. The method of claim 5, wherein the coating material is applied by steps comprising first applying the coating material uniformly to the surface of the base material and,
second applying the coating material partially to the surface of the base material to which the coating material is uniformly applied.

7. The method of claim 6, wherein, the second applying the coating material is repeated at least twice while changing the region to which the coating material is applied.

8. The method of claim 6, wherein an amount of the coating material to be applied in the second applying is about 10 wt % or greater based on an amount of the coating material in the first applying.

9. The method of claim 6, wherein the regions of the base material subjected to the second application step comprises a corner region of the base material.

10. The method of claim 1, wherein the diffusing the heavy rare-earth element comprises steps comprising:
first heating the charged base material at a temperature at which the coating material is diffused;
first cooling the heated base material to room temperature;
second heating the charged base material at a temperature at which stress inside the base material is removed; and
second cooling the heated base material to room temperature.

11. The method of claim 10, wherein the first heating is performed at a temperature of about 500 to 1,000° C. for about 1 to 50 hours.

12. The method of claim 11, wherein a heating rate in the first heating is about 0.1 to 10° C./min.

13. The method of claim 10, wherein the second heating is performed at a temperature of about 500 to 1,000° C. for about 1 to 50 hours.

14. The method of claim 13, wherein a heating rate in the second heating is about 0.1 to 10° C./min.

15. A Nd—Fe—B-based permanent magnet comprising a heavy rare-earth element diffused to a grain boundary, wherein a maximum variation between coercive forces in an inner region and an outer region is 5% or g.

16. The Nd—Fe—B-based permanent magnet of claim 15, wherein the coercive force in the inner region is about 22.5 kOe or greater.

17. The Nd—Fe—B-based permanent magnet of claim 15, wherein an average coercive force of the coercive force in the inner region and the coercive force in the outer region is about 26.0 kOe or greater.
